(19) United States
(12) Patent Application Publication
(10) Pub. No.: US 2008/0181502 A1
(43) Pub. Date: Jul. 31, 2008

(54) PATTERN RECOGNITION FOR DURING ORIENTATION OF A DISPLAY DEVICE

(76) Inventor: Hsin-Ming Yang, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/669,218

(22) Filed: Jan. 31, 2007

(51) Int. Cl. G06K 9/00

(52) U.S. Cl. 382/181

(57) ABSTRACT

A method comprises using pattern recognition to determine whether a display device is being used in a first orientation or a second orientation with respect to the user.

### BACKGROUND

Some computing devices comprise a display that can be used in any of multiple physical orientations. For example, the display can be used in a portrait or landscape mode. The user orients (e.g., rotates) the display device as desired. However, the user is inconvenienced by having to configure the graphics subsystem within the computing device that renders images on the display for whatever orientation the user has selected.

### BRIEF DESCRIPTION OF THE DRAWINGS

For a detailed description of exemplary embodiments of the invention, reference will now be made to the accompanying drawings in which:

FIG. 1 shows a perspective view of a computing device in accordance with various embodiments;

FIG. 2 shows a system diagram of the computing device of FIG. 1;

FIG. 3 illustrates the computing device being used in a first orientation with respect to the user;

FIG. 4 illustrates the computing device being used in a second orientation with respect to the user; and

FIG. 5 shows a method performed by the computing device in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

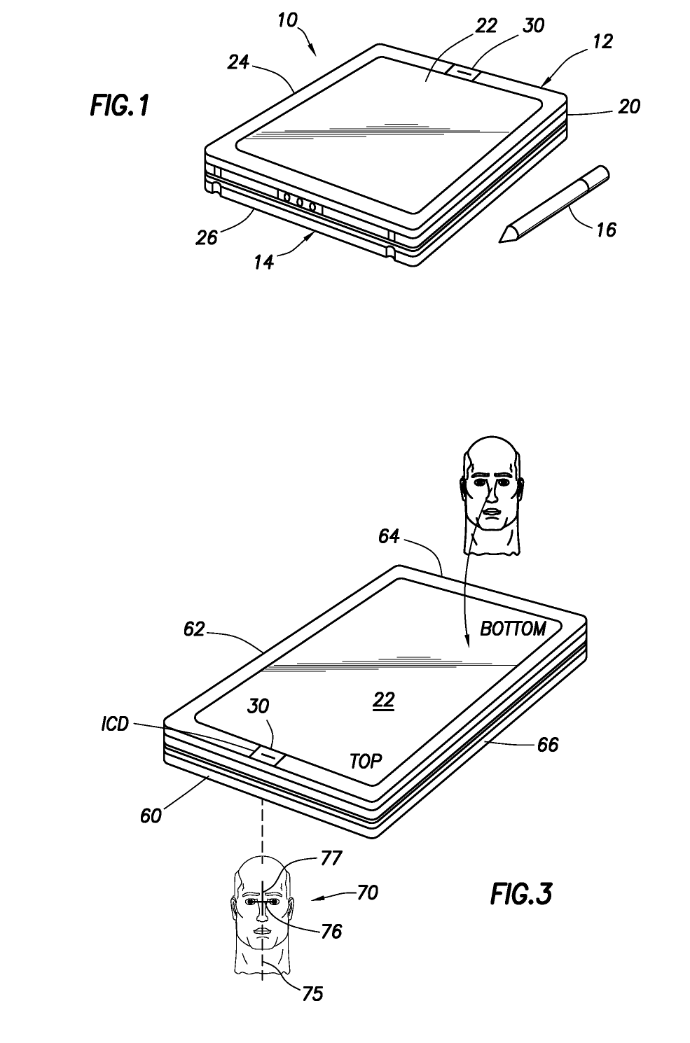

FIG. 1 is a perspective view of an exemplary computer system 10. In this exemplary embodiment, the computer system 10 comprises a tablet computing device 12, an attachable keyboard 14, and a digitizing pointing device 16, although this disclosure is not limited to tablet devices. As illustrated, the tablet computing device 12 comprises a housing 20. The housing 20 comprises a display 22 disposed in a top side 24 of the housing, a plurality of computing components and circuitry disposed within the housing 20, and the attachable keyboard 14 removably coupled to a bottom side 26 of the housing 20. The display 22 may comprise any suitable flat panel display screen technology, including a variety of screen enhancement, antireflective, protective, and other layers. The display 22 also may have touch panel technology, digitizer panel technology, and various other user-interactive screen technologies. As discussed in detail below, the digitizing pointing device 16 interacts with a digitizing panel disposed in the top side 24 of the computing device 12. The digitizing panel may be disposed below, within, or adjacent the display screen assembly 22. In this exemplary embodiment, the digitizer panel extends to a peripheral area of the display 22, where the computing device 12 defines digitizer-activated buttons for desired computing functions. The computing device 12 also may comprise a variety of user interaction circuitry and software, such as speech-to-text conversion software (i.e., voice recognition) and writing-to-text conversion software (e.g., for the digitizing pointing device 16). Accordingly, a user may interact with the computing device 12 without a conventional keyboard or mouse.

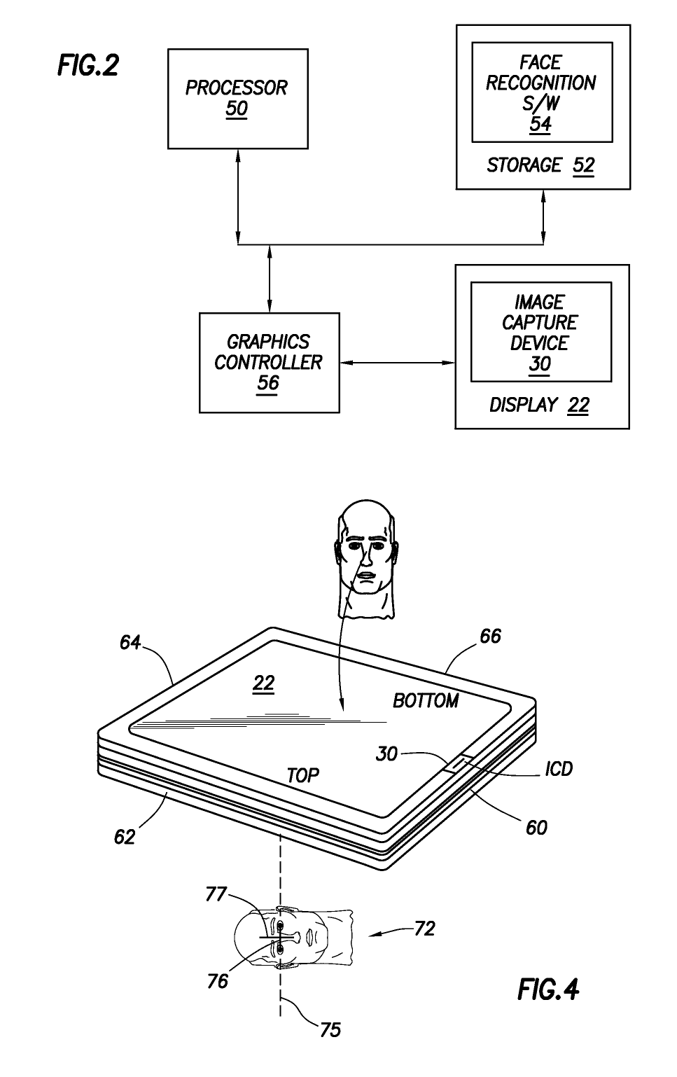

FIG. 2 illustrates a block diagram of the computing device 12. As shown, the computing device 12 comprises a processor 50 coupled to storage 52 and a graphics controller 56, which couples to the display 22. The storage comprises a computer-readable medium such as volatile memory, such as random access memory (RAM), non-volatile storage, such as a hard disk drive or compact disk read-only memory (CD ROM), or combinations thereof. The processor 50 sends graphics command and data to the graphics controller 56 which, in turn, renders the desired images on the display 22.

The computing device 12 can be used in either of multiple physical orientations with respect to a user of the computing device. For example, FIGS. 3 and 4 illustrate two different orientations. FIG. 3 illustrates a landscape mode and FIG. 4 illustrates a portrait mode which comprises the computing device 12 (i.e., display 22 rotated 90 degrees with respect to the landscape mode of FIG. 3. Thus, the user of the computing device 12 can place the computing device on a work surface (e.g., desk, table) in either the landscape or the portrait orientations and use the computing device 12 and its display 22 in either orientation. In accordance with various embodiments, the graphics controller 56 causes the images to be rendered on the display 22 appropriately in either orientation. As such, the user can readily view the images rendered on the display 22 (e.g., read text) regardless of which orientation the user has selected for interacting with the computing device.

Referring to FIGS. 3 and 4, display 22 comprises four sides 60, 62, 64, and 66. In some embodiments, the display 22 is rectangular with one pair of sides (e.g., sides 62 and 66) being of substantially equal length and being of a longer length than the other pair of sides (sides 60, 64). In some embodiments, the display 22 has a square shape, that is, all four sides are of substantially equal length.

The orientation (e.g., landscape or portrait) is discussed herein with regard to the location of the user relative to the computing device. In FIGS. 3 and 4, the user is located at the bottom of the figures with the computing device 12 resting on a work surface in front of the user. In FIG. 3, the labels “top” and “bottom” indicate the top and bottom of the display as indicated from the vantage point of the user. The top and bottom of display 22 in the orientation of FIG. 3 are sides 60 and 64, respectively. With regard to the orientation of FIG. 4, sides 62 and 66 are the top and bottom, respectively, of the display 22 with respect to the user.

FIGS. 3 and 4 show that the display 22 comprises an image capture device 30 (also shown in FIG. 1). In some embodiments, image capture device 30 comprises a camera of still images or video. Images captured by the image capture device 30 are processed by the processor 50. In accordance with various embodiments, the computing device 12 comprises pattern (e.g., face) recognition logic that determines whether the display 22 of the computing device 12 is being used in a first orientation or a second orientation with respect to the user. Based on that determination, the graphics controller 56 is configured to be operative for the first orientation if the display device is determined to be used in the first orientation. If the face recognition logic determines that the display is being used in the second orientation, the graphics controller 56 is configured to be operative for the second orientation. In both cases, the graphics controller 56 renders images viewable with regard to the orientation that the user has selected for using the computing device 12.

The storage 52 comprises software that is executed by processor 50. In some embodiments, the face recognition logic comprises face recognition software 54 (FIG. 2) which is executed by the processor 50 to perform the functionality described herein. Under control of face recognition software 54, the processor 50 receives image data from image capture device 30 and determines the physical orientation of the display 22 relative to the user to determine whether to render graphics in a landscape mode or a portrait mode.

In at least some embodiments, the face recognition software 54 causes the processor to detect one or more face landmarks on the face of the user. Such landmarks comprise, for example, the user's mouth, eyes, eyebrows, nose, lips, cheeks, etc. Based on the detection of such landmarks, the face recognition software 54 determines the orientation of the user to the image capture device 30. The image capture device 30, as shown in FIGS. 3 and 4, is attached or built-in to the display 22 at a predetermined location and thus either faces the user “head on” as indicated at 70 in FIG. 3 or from the side as indicated at 72 in FIG. 4.

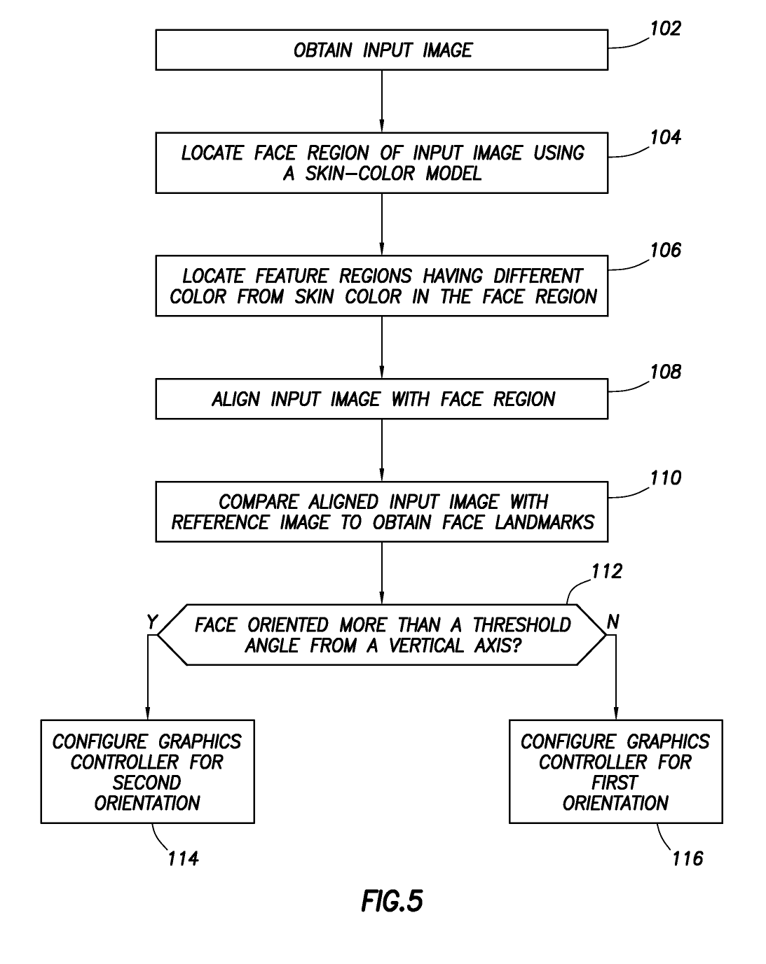

FIG. 5 shows a method 100 in accordance with various embodiments. Some, or all, of the actions of method 100 are performed by processor 50 by execution of face recognition software 54. Actions 102-110 generally enable the face recognition software to detect face landmarks from image of the user's face (which may be upright or sideways with respect to the image capture device depending on the orientation with which the user has selected to use the computing device 12). The detection of the user's face landmarks can be performed in accordance with any of a variety of face recognition techniques such as those described in the following U.S. patents, all of which are incorporated herein by reference: U.S. Pat. Nos. 7,027,622, 7,120,279, 7,146,028, and 7,155,036. Actions 102-110 depict one acceptable technique, but other techniques are usable as well.

At 102, the method 100 comprises obtaining an input image from the image capture device 30. At 104, the face recognition software 54 locates a face region of the input device using a skin-color model. At 106, the method comprises locating feature regions within the input image having a different color from the skin color in the face region. At 108, the input image is aligned with the face region. At 110, the method further comprises comparing the aligned input image with a reference image to thereby obtain face landmarks (e.g., nose, lips, eyes, etc.).

At 112, the face recognition software 54 determines whether the face is oriented by more than a threshold angle from a vertical axis. A vertical axis 75 is illustrated in FIGS. 3 and 4. FIGS. 3 and 4 also show that the user's eyes have been detected and a line 76 is computed connecting the eyes. Line 77 is computed intersecting line 76 at a 90 degree angle. If the image capture device 30 has acquired an image of the user that is sitting head-on facing the image capture device (FIG. 3), the user's face landmarks will not be more than a threshold angle from vertical axis 75. This determination is made by computing the angle of line 77 to the vertical axis 75. In FIG. 4, however, the user's face landmarks will be more than a threshold angle from vertical axis 75, as determined by computing the angle of line 77 to axis 75. The threshold can be pre-set or programmed and can be 0 or another angle to account for the user's head to be at a slight angle with regard to the vertical axis 75 of the image captured device's acquired images. In some embodiments, the threshold angle is 45 degrees.

If, as determined by decision 112 in FIG. 5, the orientation of the user's face to the vertical axis is determined to be less than the threshold angle, then the face recognition software 54 causes the graphics controller to be configured for a first orientation (e.g., portrait mode) (block 116). If, however, the orientation of the user's face to the vertical axis is determined to be more than the threshold angle, then the face recognition software 54 causes the graphics controller to be configured for a second orientation (e.g., portrait mode) (block 114).

In accordance with some embodiments, the face recognition software 54 performs method 100 automatically, that is, without user involvement. In such embodiments, for example, the face recognition software 54 executes in a background mode continually or at least periodically attempting to acquire an image of a user and compute the orientation. Thus, if the user rotates the display 22, the computing device 12 automatically changes the mode (portrait, landscape) to accommodate the changed orientation. This change occurs during run-time of the computing system. Further, the face recognition software 54 also sets the initial graphics mode based by performing method 100 during system initialization.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
using pattern recognition to determine whether a display device is being used in a first orientation or a second orientation with respect to the user.

2. The method of claim 1 further comprising configuring a graphics controller for the first orientation if the display device is determined to be used in the first orientation and for the second orientation if the display device is determined to be used in the second orientation.

3. The method of claim 1 wherein using pattern recognition to determine whether the display device is being used in the first orientation or the second orientation with respect to the user comprises using pattern recognition to determine whether a display device is being used in a landscape mode or a portrait mode with respect to the user.

4. The method of claim 1 wherein using pattern recognition to determine whether the display device is being used in the first orientation or the second orientation with respect to the user comprises automatically performing pattern recognition to determine whether the display device is being used in the first orientation or the second orientation.

5. The method of claim 1 wherein using pattern recognition comprises determining face markers on a face of the user.

6. The method of claim 1 wherein using pattern recognition comprises determining whether a face of the user is oriented more than a threshold angle from an axis.

7. A system, comprising:
a display;
a graphics controller coupled to said display; and
face recognition logic that selectively configures the graphics controller for either of a first mode or a second mode based on the physical orientation of the display relative to a user of the display.

8. The system of claim 7 wherein the face recognition logic determines the physical orientation of the display relative to the user.

9. The system of claim 8 wherein the face recognition logic determines the physical orientation by detecting face markers on a face of the user.

10. The system of claim 7 wherein the face recognition logic configures the graphics subsystem based on whether the display is in a landscape mode or a portrait mode relative to the user.

11. The system of claim 7 further comprising an image capture device whose signal is used by the face recognition logic to selectively configure the graphics controller for either of the first mode or the second mode.

12. The system of claim 7 wherein the display comprises an image capture device usable by the face recognition logic to selectively configure the graphics controller for either of the first mode or the second mode.

13. The system of claim 7 wherein the face recognition logic selectively configures the graphics controller for either of the first mode or the second mode without user input.

14. The system of claim 7 wherein the face recognition logic changes the graphics controller between a portrait mode and a landscape mode after determining whether the display is in a portrait mode or a landscape mode relative to the user.

15. A computer-readable storage medium comprising software that, when executed by a processor, cause the processor to:
selectively configure a graphics controller for either of a first mode or a second mode based on the physical orientation of a display relative to a user of the display.

16. The computer-readable storage medium of claim 15 wherein the software causes the processor to determine the physical orientation of the display relative to the user.

17. The computer-readable storage medium of claim 15 wherein the software causes the processor to detect face markers on a face of the user.

18. The computer-readable storage medium of claim 15 wherein the software causes the processor to configure the graphics controller based on whether the display is in a landscape mode or a portrait mode relative to the user.

19. The computer-readable storage medium of claim 15 wherein the software causes the processor to determine whether a face of the user is oriented more than a threshold angle from vertical.

20. The computer-readable storage medium of claim 15 wherein the software causes the processor to selectively configure the graphics controller for either of the first mode or the second mode without user input.
